(19) United States
(12) Patent Application Publication
(10) Pub. No.: US 2018/0007433 A1
(43) Pub. Date: Jan. 4, 2018

(54) FILTERING STREAMED CONTENT BY CONTENT-DISPLAY DEVICE

(71) Applicant: Intel Corporation, Santa Clara, CA (US)

(72) Inventors: RAJNEESH CHOWDHURY, Portland, OR (US); KARTHIK VEERAMANI, Hillsboro, OR (US)

(21) Appl. No.: 15/199,424

(22) Filed: Jun. 30, 2016

(51) Int. Cl. H04N 21/454; H04N 21/41

(52) U.S. Cl. CPC H04N 21/454; H04N 21/4126

(57) ABSTRACT

In embodiments, a streamed content filtering system (SCFS) may support filtering of content streamed from a content playing device (CPD) to a content display device (CDD). The CPD may include personal devices which may stream content to a CDD as well as play content on the CPD itself. The CPD may provide content-rating information (CRI) for content streamed to the CDD. The CPD and CDD may negotiate to determine that the CDD has content-filtering capabilities. The CRI may be retrieved by the CPD from the content itself or from a separate storage. Once the CRI is provided, the CDD may utilize a content filter (CF) to determine whether the content having the CRI is permitted. If not permitted, the CDD may prevent displaying of the content and/or may also display substitute content. Other embodiments may be described and/or claimed.

### TECHNICAL FIELD

The present disclosure relates to the fields of computing and content consumption. In particular, the present disclosure is related to apparatuses, methods and storage media associated with filtering of streamed content by a content-display device based on content rating information.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Various technologies, such as the Miracast wireless display standard, allow for streaming of audio/video content from a transmitter device to receiver device. Such technology is often used in public or semi-private situations. For example, a public display at a store or common area may allow for streaming of content from the mobile devices of nearby users. In other scenarios, content may be streamed to a television by members of a family in a home, such as from a phone or laptop. However, in various scenarios, the receiver device may have no way to decide whether the content being received and rendered is appropriate for the audience of the receiver device. Thus, children or other sensitive people may see or hear content which is upsetting without the ability to prevent display of such content prior to its viewing. Instead, most such scenarios depend on human intent to filter out what content is streamed to a receiver and what is not, leading to uncontrollable and potentially undesirable results.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates example components of a streamed content filtering system, in accordance with various embodiments.

FIG. 2 illustrates an example process for the streamed content filtering system to stream filtered content, in accordance with various embodiments.

FIG. 3 illustrates an example process for the streamed content filtering system to set up a content stream with content filtering, in accordance with various embodiments.

FIG. 4 illustrates an example process for the streamed content filtering system to begin streaming of content, in accordance with various embodiments.

FIG. 5 illustrates an example process for the streamed content filtering system to control display of content, in accordance with various embodiments.

FIG. 6 illustrates an example computing environment suitable for practicing various aspects of the present disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs having machine instructions (generated from an assembler or compiled from higher level languages, a combinational logic circuit, and/or other suitable components that provide the described functions/functionalities. As described herein, the term “logic” and “module” may refer to, be part of, or include a System on a Chip, as described below.

In various embodiments, a streamed content filtering system (SCFS) may be configured to support filtering of content that is streamed from a content playing device (CPD) to a content display device (CDD). In various embodiments, the CPD may include personal devices, such as mobile phones, tablets, touch devices, and/or laptops, which may be configured to stream content to a CDD as well as render/play content onto a display device/screen of the CPD itself. The CDD may be associated with a public or semi-public display, such as a display in a mall, store, or other public area, or in a home where multiple people may be able to view the display.

In various embodiments, the CPD may be configured to provide content-rating information (CRI) for a particular piece of content streamed or to be streamed to the CDD. Prior to streaming of the CRI or displaying of the streamed content by the CDD, the CPD and CDD may negotiate to determine that the CDD has content-filtering capabilities. If so, the CRI may be retrieved by the CPD from the content itself or from a separate content-rating information storage. Once the CRI is provided to the CDD, the CDD may utilize a content filter (CF) to determine whether the content having the CRI is permitted or not permitted to be displayed/outputted on the CDD, such as according to filtering restrictions which have been configured at the CDD. If not permitted, the CDD may be configured to prevent displaying/outputing of the content. The CDD may also display/output a substitute content, such as a message indicating that the streamed content is not permitted. By preventing displaying/outputting of the non-permitted content, the CDD may thus prevent viewing of undesired content by sensitive viewers/listeners.

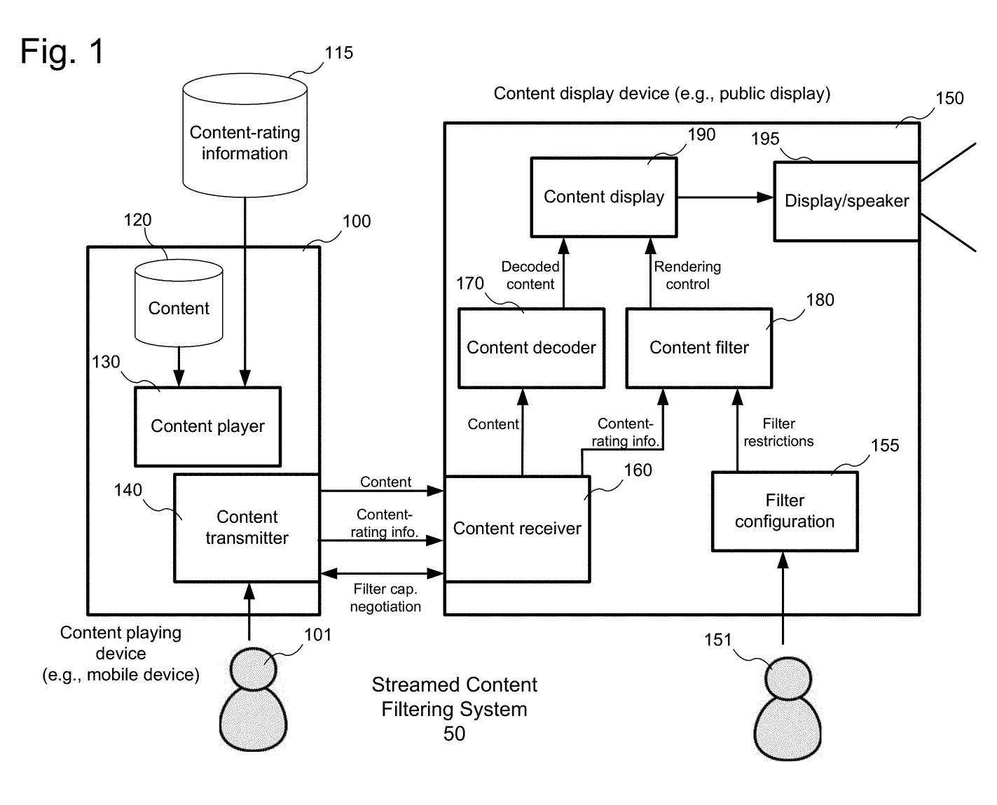

FIG. 1 illustrates components of a SCFS 50, in accordance with various embodiments. In various embodiments, various components may be described and/or illustrated as being coupled. It may be recognized that such coupling may include, in various embodiments, electric coupling, communicative coupling and/or operative coupling. Additionally couplings may include persistent or non-persistent couplings. Additionally, in various embodiments, components may be coupled to each other directly or through communication with intermediate components.

As illustrated, the SCFS 50 may include a CPD 100 and a CDD 150. In various embodiments, the CPD 100 may be configured with content player (CP) 130 to play content from content storage 120 on display device/screen of CPD 100 or coupled to CPD 100. CPD 100 may also be configured with content transmitter (CT) 140 to stream content, such as audio or video content, to the CDD 150. In various embodiments, the CPD 100 may be configured to stream content according to known streaming techniques, such as, for example, the real-time streaming protocol (RTSP). In various embodiments, as mentioned above, the CPD 100 may include various types of devices which may be controlled by a user 101, such as, for example, mobile phones, tablets, laptop computers, wearable devices, etc. In various embodiments, the CPD 100 may include devices on which content may itself be viewed, such as the devices listed above. Thus, in some embodiments, the CPD 100 may be configured to stream content which is being displayed on or by the CPD 100 or which has been displayed on or by the CPD 100, such as by sharing a screen of the CPD 100.

In various embodiments, the CDD 150 may include displays, such as liquid crystal displays (LCDs) or light-emitting diode (LED) displays to render video, and/or speakers to render audio. In various embodiments, the SCFS 50 may include multiple CPD 100s, such as, for example, if multiple phones or other personal devices are connected to a single CDD 150. These multiple CPD 100s may, simultaneously and/or in series, stream content to a publicly viewable (or listenable) CDD 150.

In various embodiments, the CPD 100 and/or CDD 150 may include various modules which may be configured to perform filtering of streamed content according to embodiments described herein. As described earlier, the CPD 100 may include CP 130 and/or CT 140. In various embodiments, the CP 130 may be configured to retrieve or otherwise obtain CRI for a piece of content, such as from the content itself (which may be stored in an internal content storage 120) or from an external source, such as CRI storage 115. In various embodiments, the CT 140 may be configured to stream the content to the CDD 150, as well as to transmit the CRI to the CDD 150. In various embodiments, the streaming of content and of the CRI may be performed in response to a selection of a piece of content for streaming, such as by user 101.

In various embodiments, the CDD 150 may include a content receiver 160 (CR 160) which may be in communication with the CPD 100, and specifically with the CT 140, to receive streamed content and transmitted CRI from the CT 140. In various embodiments, the CT 140 may be configured to stream content as an encoded audio-video stream in MPEG2-TS format. In various embodiments, the CT 140 may be configured to transmit CRI through a TCP/UDP channel negotiated with the CR 160 through RTSP. In alternative embodiments, the CT 140 may embed the CRI in the form of a vendor extension in the video stream's container format's packet header (for example an MPEG2-TS or RTP header).

In various embodiments the CT 140 and the CR 160 may also be configured to negotiate with each other to determine content-filtering capabilities of the CDD 150. In various embodiments, such negotiation may be performed as part of the RTSP. For example, negotiation may be performed as part of the M3 phase of the RTSP. In various embodiments, the M3 phase may include to sending of an RTSP GET_PARAMETER message sent from a source to a sink (e.g. from the CPP 100 to the CDD 150) requesting capabilities of the sink. In various embodiments, the RTSP negotiation may include the following format:

| | |
|---|---|
| wfd-content-filter-capability | = “wfd_content_filter_capability:” SP |
| | (“none” / content-filter-capability) CRLF; |
| | “non” indicates no support for filtering |
| content-rating-data-port | = “port=” SP “protocol=” (“TCP”/”UDP”) |

In various embodiments, the CDD 150 may include a content decoder 170 (CD 170). The CD 170 may be configured to decode streamed audio/video content received from the CR 160. In various embodiments, the CD 170 may decode the content according to known techniques. The decoded content may, in turn, be provided to a content display module 190 (CDM 190). The CDM 190 may then display/output the content, such as on an associated display and/or speaker 195 (DS 195). In various embodiments, the DS 195 may be incorporated into the CDD 150, as illustrated; in other embodiments, the DS 195 may be included in a separate device, such as a separate display or speaker unit. In various embodiments, the CDM 190 may be configured to display/output the decoded content according to various known techniques.

In various embodiments, the CDD 150 may include a content filter 180 (CF 180), which may be coupled to the CR 160 and/or the CD 170 and which may be configured to control the CDM 190 based on CRI. The CRI may be provided from the CR 160 after the CR 160 receives the CRI from the CT 140. In various embodiments, the CF 180 may control the rendering by the CDM 190 based in part on filter restrictions provided by filter configuration 155 (FC 155). In various embodiments, these filter restrictions may include age-related restrictions; content-specific restrictions such as restrictions on nudity, language, violence, etc., and/or other types of restrictions, as may be understood. In various embodiments, the FC 155 may be configurable by a user 151 to pre-configure filter restrictions for the CF 180.

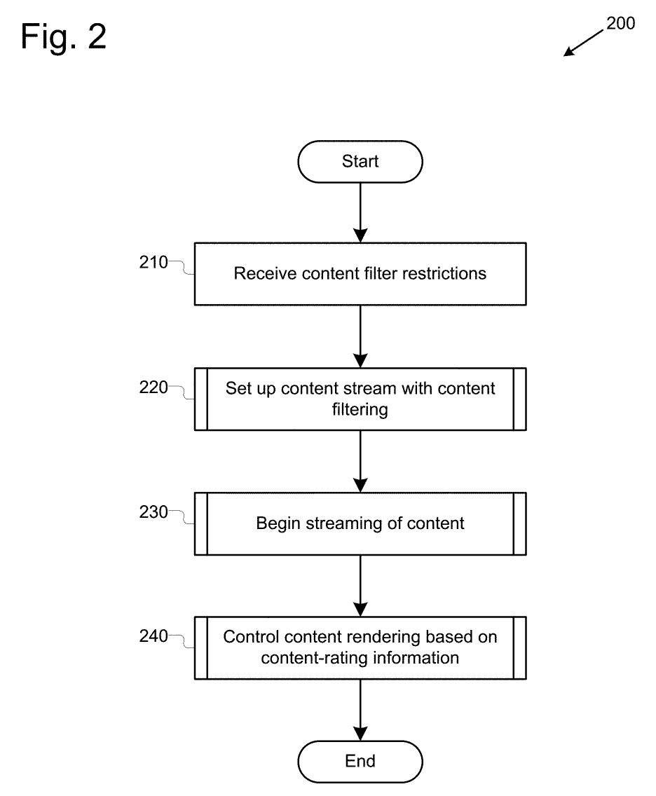

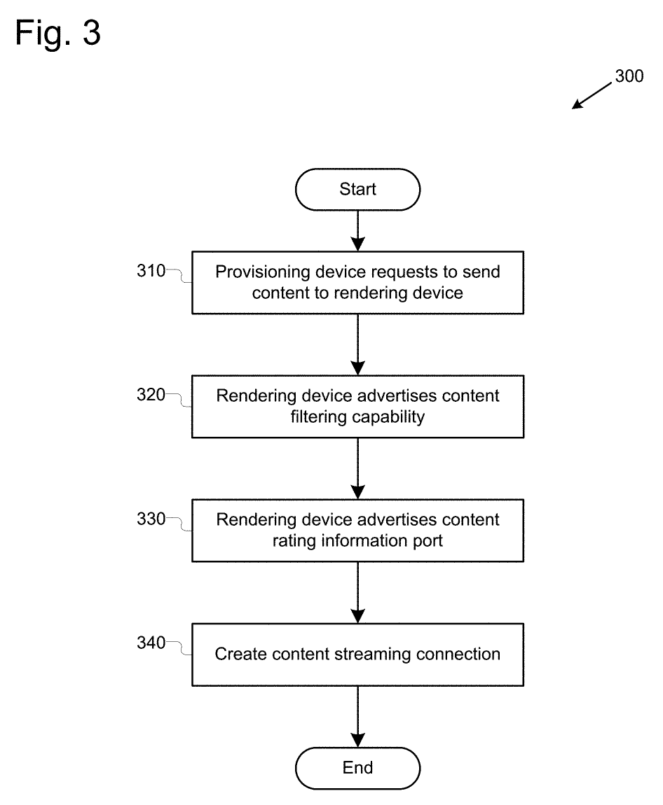

FIG. 2 illustrates an example process 200 for the SCFS to stream filtered content, in accordance with various embodiments. In various embodiments, algorithmic structures for the various modules of the CPD 100 and CDD 150 may be described with reference to FIG. 2. It may be noted that, while particular ordering of information flows are illustrated, in various embodiments, operations may be otherwise ordered or omitted, or additional operations may be included. The process may begin at operation 210, where the CF 180 of the CRP 150 may receive filter restrictions, such as from the user 151 providing the filter restrictions through the FC 155. Next, at operation 220, the CPD 100 and the CRP 150 may set up a content stream with content filtering. At operation 220, content-filtering capabilities may be negotiated and a stream connection may be established. In various embodiments, particular implementation details of operation 220 may be described below with reference to process 300 of FIG. 3. Next, at operation 220, the CPD 100 and the CRP 150 may set up a content stream with content filtering. In various embodiments, particular implementation details of operation 220 may be described below with reference to process 300 of FIG. 3.

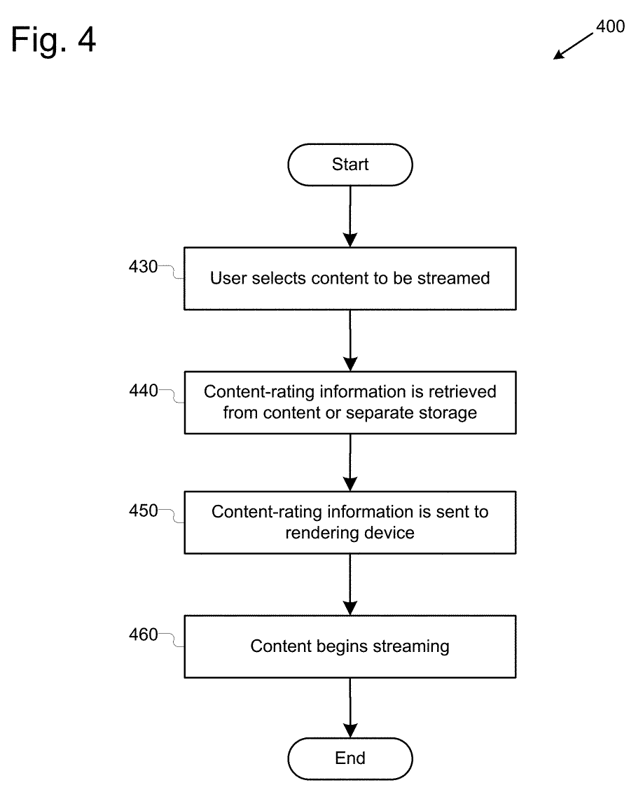

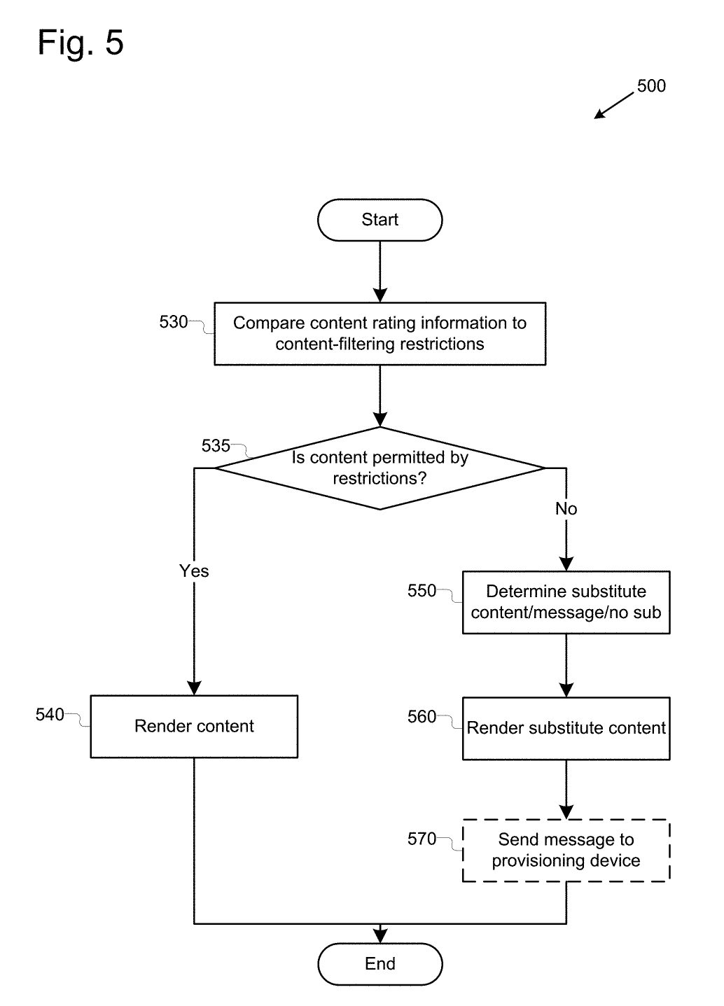

Next, at operation 230, the CPD 100 may begin streaming of content, such as content selected by the user 101 of the CPD 100. In various embodiments, this content may be mirrored from a display of the CPD 100. In various embodiments, mirroring of a display may be performed according to various known techniques, including sharing of all or a part of a display of the CPD 100. In some embodiments, a window or a portion of a display may be chosen for mirroring, or an entire display may be mirrored. In various embodiments, particular implementation details of operation 230 may be described below with reference to process 400 of FIG. 4. Next, at operation 240, the CF 180 may control content rendering by the CDM 190 based on CRI which has been received along with the content. In various embodiments, particular implementation details of operation 240 may be described below with reference to process 500 of FIG. 5. After operation 240, the process may then end.

FIG. 3 illustrates an example process 300 for the SCFS to set up a content stream with content filtering, in accordance with various embodiments. In various embodiments, process 300 may perform various embodiments of operation 220 of process 200 of FIG. 2. In various embodiments, algorithmic structures for the various modules of the CPD 100 and CDD 150 may be described with reference to FIG. 3. It may be noted that, while particular ordering of information flows are illustrated, in various embodiments, operations may be otherwise ordered or omitted, or additional operations may be included. The process may begin at operation 310, where the CPD 100 sends a request to the CDD 150 to stream content to the CDD 150. In various embodiments this request may be made as part of a RTSP. Next, at operation 320, the CRP 100 may, as part of a negotiation, advertise content-filtering capabilities to the CPD 100, such as using the protocol extensions described above with reference to FIG. 1. Next, at operation 330, the CDD 150 may advertise a port for receipt of CRI, such as using the protocol extensions described above with reference to FIG. 1. Finally, at operation 340, the CPD 100 and the CDD 150 may create a content streaming connection, such as may be understood. The process may then end.

FIG. 4 illustrates an example process 400 for the SCFS to begin streaming of content, in accordance with various embodiments. In various embodiments, process 400 may perform various embodiments of operation 230 of process 200 of FIG. 2. In various embodiments, algorithmic structures for the various modules of the CPD 100 and CDD 150 may be described with reference to FIG. 4. It may be noted that, while particular ordering of information flows are illustrated, in various embodiments, operations may be otherwise ordered or omitted, or additional operations may be included. The process may begin at operation 430, where the user 101 may select content to be streamed from the CPD 100 to the CDD 150. In various embodiments, the user 101 may select a specific piece of content from storage of the CPD 100 or from a networked resource in connection with the CPD 100. In other embodiments, the user 101 may elect to mirror all or part of a screen of the CPD 100, such as by mirroring a mobile phone screen.

Next, at operation 440, the CP 130 may retrieve CRI. In various embodiments, the CRI may be retrieved from the selected content itself or from separate CRI storage 115. Next, at operation 450, the CT 140 of the CPD 100 may transmit the retrieved CRI to the CR 160 of the CDD 150. As discussed above, in various embodiments, the CT 140 may be configured to transmit CRI through a TCP/UDP channel negotiated with the CR 160 through RTSP. In alternative embodiments, the CT 140 may embed the CRI in the form of a vendor extension in the video stream's container format's packet header (for example an MPEG2-TS or RTP header). Finally, at operation 460, the CR 140 may begin streaming of the content to the CT 160. The process may then end.

FIG. 5 illustrates an example process 500 for the SCFS to control rendering of content, in accordance with various embodiments. In various embodiments, process 500 may perform various embodiments of operation 240 of process 200 of FIG. 2. In various embodiments, algorithmic structures for the various modules of the CDD 150 may be described with reference to FIG. 5. It may be noted that, while particular ordering of information flows are illustrated, in various embodiments, operations may be otherwise ordered or omitted, or additional operations may be included. The process may begin at operation 530, where the CF 180 may compared the received CRI to the previously configured filtering restrictions. At decision operation 535, the CF 180 may determine whether the content is permitted according to the filtering restrictions. If so, then at operation 540, the CDM 190 may render the content on the DS 195 and the process may end.

However, if, at decision operation 535 the CF 180 determines that the content is not permitted, then at operation 550, the CF 180 may determine substitute content for the restricted content. In various embodiments, the CF 180 may substitute a different type of content, such as an alternative piece of video or audio. In another embodiment, the CF 180 may substitute a message, such as a message explaining that the content is restricted. In some embodiments, the message may explain which particular restrictions were violated by the CRI of the streamed content. In yet other embodiments, the CF 180 may substitute no content, such as a blank or solid-color piece of video, or silence. Next, at operation 560, the CF 180 may control the CDM 190 to render the substitute content in the place of the restricted streamed content. Finally, at operation 570, the CF 180 may optionally send a message to the CPD 100 to inform the user 101 that the content was restricted. The process may then end.

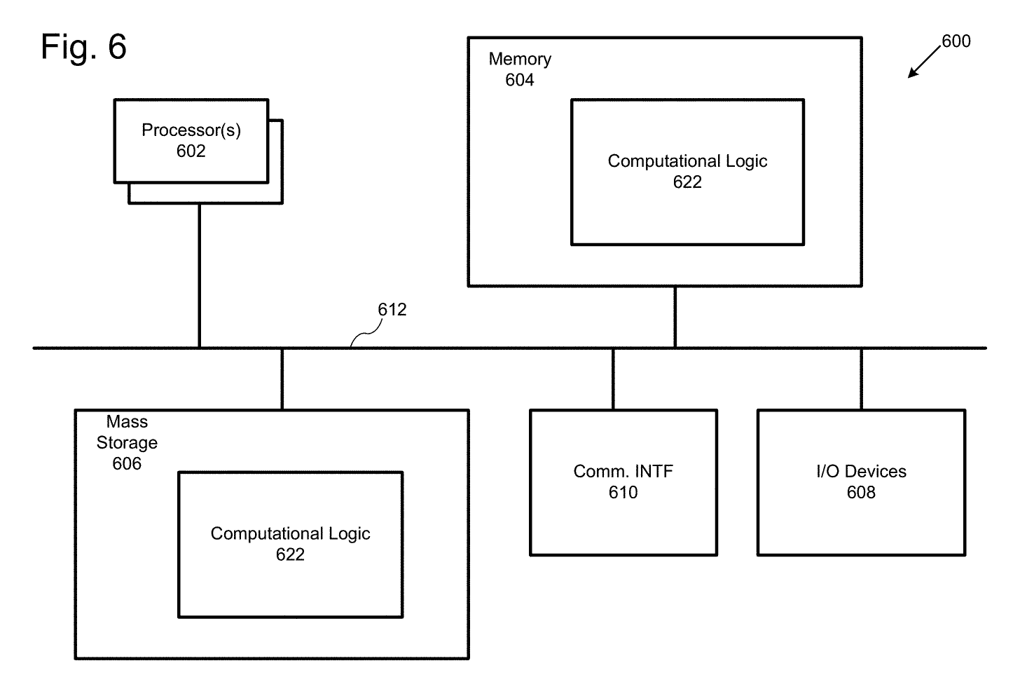

Referring now to FIG. 6, a block diagram of an example architecture of a computing device suitable for use to practice as either the CPD 100 or the CDD 150, in accordance with various embodiments, is illustrated. As shown, computing device 600 may include one or more processors 602, each having one or more processor cores, and persistent memory 604. Additionally, computing device 600 may include communication interfaces 610, such as, Ethernet, WiFi, Bluetooth, 3G/4G and so forth, and I/O device 608 may include cameras, display devices, keyboard, cursor control and so forth. The elements may be coupled to each other via system bus 606, which may represent one or more buses. In the case of multiple buses, they may be bridged by one or more bus bridges (not shown).

Each of these elements may perform its conventional functions known in the art. In particular, persistent memory 604 may be employed to store a copy of computing logic 622 implementing some or all of the operations described earlier, e.g., but not limited to, retrieving of content, retrieving of content rating information, playing of content, streaming of content, transmission of CRI, decoding of content, displaying/outputting of decoded streamed content, filtering of streamed content, and so forth, performed by CP 130, CT 140, CR 160, CD 170, and/or CDM 190, and so forth. Computing logic 622 may be implemented in assembler instructions supported by processor(s) 602 or high-level languages, such as, for example, C or a scripting language, that can be compiled into such instructions. The programming instructions may be placed into persistent memory 604 in the factory, or in the field, through, for example, a distribution medium (not shown), such as a compact disc, or through communication interface 610 (from a distribution server (not shown)). The number, capability and/or capacity of these elements 602-610 may vary from embodiments to embodiments and/or depending on whether computing device 600 is used as CPD 100 or CDD 150. The constitutions of these elements 602-610 are otherwise known, and accordingly will not be further described.

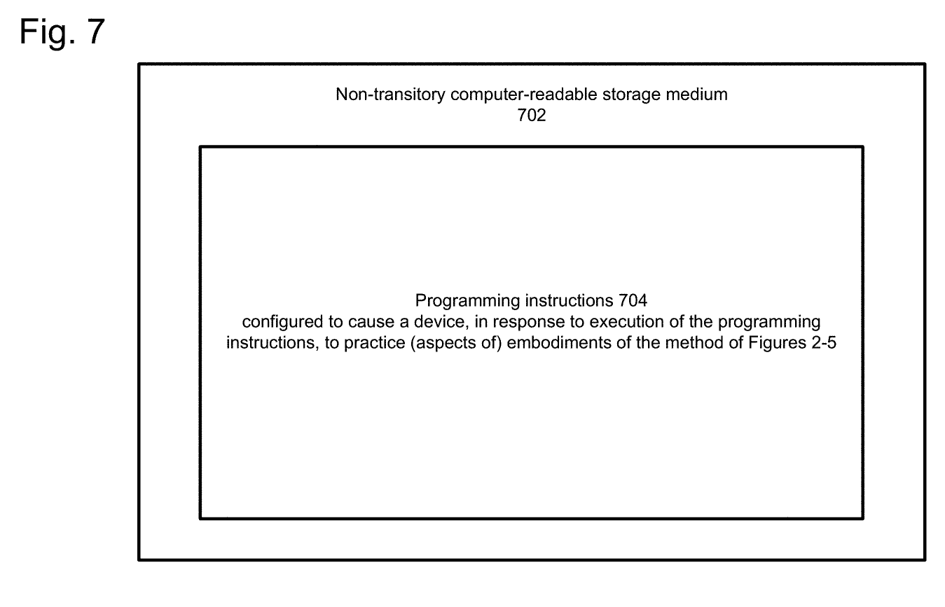

FIG. 7 illustrates an example non-transitory computer-readable storage medium having instructions configured to practice all or selected ones of the operations associated with the CPD 100 or the CDD 150, and so forth, earlier described, in accordance with various embodiments. As illustrated, non-transitory computer-readable storage medium 702 may include a number of programming instructions 704. Programming instructions 704 may be configured to enable a device, e.g., CPD 100 or the CDD 150, in response to execution of the programming instructions, to perform various operations earlier described, including but not limited to, retrieving of content, retrieving of content rating information, playing of content, streaming of content, transmission of CRI, decoding of content, displaying/outputting of decoded streamed content, filtering of streamed content, and so forth, performed by CP 130, CT 140, CR 160, CD 170, and/or CDM 190, and so forth. In alternate embodiments, programming instructions 704 may be disposed on multiple non-transitory computer-readable storage media 702 instead. In still other embodiments, programming instructions 704 may be encoded in transitory computer readable signals. The programming instruction may also include piece of software that protects or encrypts the data in the memory, storage, data being processed, and in communication channel being exposed to the hackers.

Referring back to FIG. 6, for one embodiment, at least one of processors 602 may be packaged together with a computer-readable storage medium having computing 622 (in lieu of storing in system memory 604) configured to practice all or selected aspects of the earlier described operations. For one embodiment, at least one of processors 602 may be packaged together with a computer-readable storage medium having computing logic 622 to form a System in Package (SiP). For one embodiment, at least one of processors 602 may be integrated on the same die with a computer-readable storage medium having computing logic 622. For one embodiment, at least one of processors 602 may be packaged together with a computer-readable storage medium having computing logic 622 to form a System on Chip (SoC).

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques. Particular examples of embodiments, described herein include, but are not limited to, the following:

Example 1 may include a content-display device. The content-display device may include one or more computer processors. The content-display device may also include a content receiver to: accept, from a content-playing device, a connection request to stream content from the content-playing device; and receive, from the content-playing device, streamed content which can be rendered on the content-playing device, and content-rating information of the streamed content. The content-display device may also include a content display module to operate on the one or more computer processors to display the streamed media. The content-display device may also include a content filter coupled with the content receiver and the content display module to control display of streamed content by the content display module based on the received content-rating information.

Example 2 may include the content-display device of example 1, wherein the streamed content may be rendered by the content-playing device at the time of streaming.

Example 3 may include the content-display device of example 2, wherein the streamed content may be a mirror of all or part of a content displayed on a display device connected to the content-playing device.

Example 4 may include the content-display device of example 2, wherein the streamed content may be a mirror of all or part of a content displayed on a display device which may be a part of the content-playing device.

Example 5 may include the content-display device of any of examples 1-4, wherein the content-playing device may be a mobile device.

Example 6 may include the content-display device of any of examples 1-4, wherein the content filter may be to control display by preventing the content display module from displaying the streamed content.

Example 7 may include the content-display device of any of examples 1-4, wherein to control display, the content filter may be to compare the received content-rating information to pre-configured filter restrictions on the content-display device.

Example 8 may include the content-display device of example 7, wherein: the content contains audio; and to control display, the control filter may be to cause the display module to output audio other than the audio of the content when the received content-rating information does not comply with the pre-configured filter restrictions on the content-display device.

Example 9 may include the content-display device of example 8, wherein the control filter may be to cause the display module to output no audio when the received content-rating information does not comply with the pre-configured filter restrictions on the content-display device.

Example 10 may include the content-display device of example 7, wherein: the content contains video; and to control display, the control filter may be to cause the display module to output video other than the video of the content.

Example 11 may include the content-rendering device of example 10, wherein the control filter may be to cause the display module to output a blank screen or window when the received content-rating information does not comply with the pre-configured filter restrictions on the content-display device.

Example 12 may include the content-rendering device of example 10, wherein the control filter may be to cause the display module to output text when the received content-rating information does not comply with the pre-configured filter restrictions on the content-display device.

Example 13 may include the content-display device of any of examples 1-4, wherein the content receiver may be to provide an indication to the content-playing device that the content-display device supports filtering of streamed content based on rating information.

Example 14 may include the content-display device of example 13, wherein the content receiver may be to provide an indication to the content-playing device that the content-display device supports filtering of streamed content based on rating information, through performance of a negotiation with the content-playing device to determine content-filtering capabilities of the content-display device.

Example 15 may include a content-playing device. The content-playing device may include one or more computer processors and a content player to play content. The content-playing device may also include a content transmitter to: receive, from a content-display device, an indication that the content-display device supports filtering of streamed content based on rating information; stream content which can be played by the content-playing device to the content-display device to display the streamed content; and transmit content rating information about the streamed content to the content-display device to facilitate control of display of the streamed content.

Example 16 may include the content-playing device of example 15, further including a storage to: store a copy of the streamed content; and store the content rating information for the streamed content.

Example 17 may include the content-playing device of example 15, wherein the content transmitter may be to perform a negotiation with the content-display device to receive an indication that the content-display device supports filtering of streamed content based on rating information.

Example 18 may include a method for displaying content, including: accepting, by a content-display device, from a content-playing device, a connection request to stream content from the content-playing device; receiving, by the content-display device, from the content-playing device, streamed content which can be rendered on the content-playing device, and content-rating information of the streamed content; and controlling, by the content-display device, display of streamed content by the content display module based on the received content-rating information.

Example 19 may include the method of example 18, wherein the streamed content may be rendered by the content-playing device at the time of streaming.

Example 20 may include the method of example 19, wherein the streamed content may be a mirror of all or part of a content displayed on a display device connected to the content-playing device.

Example 21 may include the method of example 18, wherein the streamed content may be a mirror of all or part of a content displayed on a display device which may be a part of the content-playing device.

Example 22 may include the method of any of examples 18-21, wherein the content-playing device may be a mobile device.

Example 23 may include the method of any of examples 18-21, wherein controlling display may include preventing display of the streamed content.

Example 24 may include the method of any of examples 18-21, wherein controlling display may include comparing the received content-rating information to pre-configured filter restrictions on the content-display device.

Example 25 may include the method of example 24, wherein: the content contains audio and controlling display may include outputting audio other than the audio of the content when the received content-rating information does not comply with the pre-configured filter restrictions on the content-display device.

Example 26 may include the method of example 25, wherein outputting audio may include outputting no audio when the received content-rating information does not comply with the pre-configured filter restrictions on the content-display device.

Example 27 may include the method of example 24, wherein: the content contains video and controlling display may include outputting video other than the video of the content.

Example 28 may include the method of example 27, wherein outputting video other than the video of the content may include outputting a blank screen or window when the received content-rating information does not comply with the pre-configured filter restrictions on the content-display device.

Example 29 may include the method of example 27, wherein outputting video other than the video of the content may include outputting text when the received content-rating information does not comply with the pre-configured filter restrictions on the content-display device.

Example 30 may include the method of example 18, further including providing, by the content-display device, an indication to the content-playing device that the content-display device supports filtering of streamed content based on rating information.

Example 31 may include the method of example 30, wherein providing an indication to the content-playing device that the content-display device supports filtering may include negotiating with the content-playing device to determine content-filtering capabilities of the content-display device.

Example 32 may include a method for streaming content, including: receiving, by a content-playing device, from a content-display device, an indication that the content-display device supports filtering of streamed content based on rating information; streaming, by the content-playing device, content which can be played by the content-playing device to the content-display device to display the streamed content; and transmitting, by the content-playing device, content rating information about the streamed content to the content-display device to facilitate control of display of the streamed content.

Example 33 may include the method of example 32, further including: storing, by the content-playing device, a copy of the streamed content; and storing, by the content-playing device, the content rating information for the streamed content.

Example 34 may include the method of example 32, further including performing, by the content-playing device, a negotiation with the content-display device to receive an indication that the content-display device supports filtering of streamed content based on rating information.

Example 35 may include one or more computer-readable media containing instructions written thereon that, in response to execution on a content-display device, cause the content-display device to: accept, from a content-playing device, a connection request to stream content from the content-playing device; receive, from the content-playing device, streamed content which can be rendered on the content-playing device, and content-rating information of the streamed content; and control display of streamed content by the content display module based on the received content-rating information.

Example 36 may include the one or more computer-readable media of example 35, wherein the streamed content may be rendered by the content-playing device at the time of streaming.

Example 37 may include the one or more computer-readable media of example 36, wherein the streamed content may be a mirror of all or part of a content displayed on a display device connected to the content-playing device.

Example 38 may include the one or more computer-readable media of example 35, wherein the streamed content may be a mirror of all or part of a content displayed on a display device which may be a part of the content-playing device.

Example 39 may include the one or more computer-readable media of any of examples 35-38, wherein the content-playing device may be a mobile device.

Example 40 may include the one or more computer-readable media of any of examples 35-38, wherein control display may include prevent display of the streamed content.

Example 41 may include the one or more computer-readable media of any of examples 35-38, wherein control display may include compare the received content-rating information to pre-configured filter restrictions on the content-display device.

Example 42 may include the one or more computer-readable media of example 41, wherein the content contains audio and control display may include output audio other than the audio of the content when the received content-rating information does not comply with the pre-configured filter restrictions on the content-display device.

Example 43 may include the one or more computer-readable media of example 42, wherein output audio may include output no audio when the received content-rating information does not comply with the pre-configured filter restrictions on the content-display device.

Example 44 may include the one or more computer-readable media of example 41, wherein the content contains video and control display may include output video other than the video of the content.

Example 45 may include the one or more computer-readable media of example 44, wherein output video other than the video of the content may include output a blank screen or window when the received content-rating information does not comply with the pre-configured filter restrictions on the content-display device.

Example 46 may include the one or more computer-readable media of example 44, wherein output video other than the video of the content may include output text when the received content-rating information does not comply with the pre-configured filter restrictions on the content-display device.

Example 47 may include the one or more computer-readable media of example 35, wherein the instructions are further to cause the content-display device to provide an indication to the content-playing device that the content-display device supports filtering of streamed content based on rating information.

Example 48 may include the one or more computer-readable media of example 47, wherein provide an indication to the content-playing device that the content-display device supports filtering may include negotiate with the content-playing device to determine content-filtering capabilities of the content-display device.

Example 49 may include one or more computer-readable media containing instructions written thereon that, in response to execution on a content-playing device, cause the content-playing device to: receive, from a content-display device, an indication that the content-display device supports filtering of streamed content based on rating information; stream content which can be played by the content-playing device to the content-display device to display the streamed content; and transmit content rating information about the streamed content to the content-display device to facilitate control of display of the streamed content.

Example 50 may include the one or more computer-readable media of example 49, wherein the instructions are further to cause the content-playing device to store a copy of the streamed content and store the content rating information for the streamed content.

Example 51 may include the one or more computer-readable media of example 49, wherein the instructions are further to cause the content-playing device to perform a negotiation with the content-display device to receive an indication that the content-display device supports filtering of streamed content based on rating information.

Example 52 may include a content-display apparatus, including: means for accepting, from a content-playing device, a connection request to stream content from the content-playing device; means for receiving, from the content-playing device, streamed content which can be rendered on the content-playing device, and content-rating information of the streamed content; and means for controlling display of streamed content by the content display module based on the received content-rating information.

Example 53 may include the content-display apparatus of example 52, wherein the streamed content may be rendered by the content-playing device at the time of streaming.

Example 54 may include the content-display apparatus of example 53, wherein the streamed content may be a mirror of all or part of a content displayed on a display device connected to the content-playing device.

Example 55 may include the content-display apparatus of example 52, wherein the streamed content may be a mirror of all or part of a content displayed on a display device which may be a part of the content-playing device.

Example 56 may include the content-display apparatus of any of examples 52-55, wherein the content-playing device may be a mobile device.

Example 57 may include the content-display apparatus of any of examples 52-55, wherein means for controlling display include means for preventing display of the streamed content.

Example 58 may include the content-display apparatus of any of examples 52-55, wherein means for controlling display may include means for comparing the received content-rating information to pre-configured filter restrictions on the content-display apparatus.

Example 59 may include the content-display apparatus of example 58, wherein the content contains audio and means for controlling display include means for outputting audio other than the audio of the content when the received content-rating information does not comply with the pre-configured filter restrictions on the content-display apparatus.

Example 60 may include the content-display apparatus of example 59, wherein means for outputting audio include means for outputting no audio when the received content-rating information does not comply with the pre-configured filter restrictions on the content-display apparatus.

Example 61 may include the content-display apparatus of example 59, wherein the content contains video and means for controlling display include means for outputting video other than the video of the content.

Example 62 may include the content-display apparatus of example 61, wherein means for outputting video other than the video of the content include means for outputting a blank screen or window when the received content-rating information does not comply with the pre-configured filter restrictions on the content-display apparatus.

Example 63 may include the content-display apparatus of example 61, wherein means for outputting video other than the video of the content include means for outputting text when the received content-rating information does not comply with the pre-configured filter restrictions on the content-display apparatus.

Example 64 may include the content-display apparatus of example 52, further including means for providing an indication to the content-playing device that the content-display apparatus supports filtering of streamed content based on rating information.

Example 65 may include the content-display apparatus of example 64, wherein means for providing an indication to the content-playing device that the content-display apparatus supports filtering include means for negotiating with the content-playing device to determine content-filtering capabilities of the content-display apparatus.

Example 66 may include a content-playing apparatus, including: means for receiving, from a content-display device, an indication that the content-display device supports filtering of streamed content based on rating information; means for streaming, content which can be played by the content-playing apparatus to the content-display device to display the streamed content; and means for transmitting content rating information about the streamed content to the content-display device to facilitate control of display of the streamed content.

Example 67 may include the content-playing apparatus of example 66, further including: means for storing a copy of the streamed content and means for storing the content rating information for the streamed content.

Example 68 may include the content-playing apparatus of example 66, further including means for performing a negotiation with the content-display device to receive an indication that the content-display device supports filtering of streamed content based on rating information.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A content-display device, comprising:
one or more computer processors;
a content receiver to:
accept, from a content-playing device, a connection request to stream content from the content-playing device; and
receive, from the content-playing device, streamed content which can be rendered on the content-playing device, and content-rating information of the streamed content;
a content display module to operate on the one or more computer processors to display the streamed media; and
a content filter coupled with the content receiver and the content display module to control display of streamed content by the content display module based on the received content-rating information.

2. The content-display device of claim 1, wherein the streamed content is being rendered by the content-playing device at the time of streaming.

3. The content-display device of claim 2, wherein the streamed content is a mirror of all or part of a content displayed on a display device connected to the content-playing device.

4. The content-display device of claim 2, wherein the streamed content is a mirror of all or part of a content displayed on a display device which is a part of the content-playing device.

5. The content-display device of claim 1, wherein the content-playing device is a mobile device.

6. The content-display device of claim 1, wherein the content filter is to control display by preventing the content display module from displaying the streamed content.

7. The content-display device of claim 1, wherein to control display, the content filter is to compare the received content-rating information to pre-configured filter restrictions on the content-display device.

8. The content-display device of claim 7, wherein:
the content contains audio; and
to control display, the control filter is to cause the display module to output audio other than the audio of the content when the received content-rating information does not comply with the pre-configured filter restrictions on the content-display device.

9. The content-display device of claim 8, wherein the control filter is to cause the display module to output no audio when the received content-rating information does not comply with the pre-configured filter restrictions on the content-display device.

10. The content-display device of claim 7, wherein:
the content contains video; and
to control display, the control filter is to cause the display module to output video other than the video of the content.

11. The content-rendering device of claim 10, wherein the control filter is to cause the display module to output a blank screen or window when the received content-rating information does not comply with the pre-configured filter restrictions on the content-display device.

12. The content-rendering device of claim 10, wherein the control filter is to cause the display module to output text when the received content-rating information does not comply with the pre-configured filter restrictions on the content-display device.

13. The content-display device of claim 1, wherein the content receiver is to provide an indication to the content-playing device that the content-display device supports filtering of streamed content based on rating information.

14. The content-display device of claim 13, wherein the content receiver is to provide an indication to the content-playing device that the content-display device supports filtering of streamed content based on rating information, through performance of a negotiation with the content-playing device to determine content-filtering capabilities of the content-display device.

15. A content-playing device, comprising:
one or more computer processors;
a content player to play content; and
a content transmitter to:
receive, from a content-display device, an indication that the content-display device supports filtering of streamed content based on rating information;
stream content which can be played by the content-playing device to the content-display device to display the streamed content; and
transmit content rating information about the streamed content to the content-display device to facilitate control of display of the streamed content.

16. The content-playing device of claim 15, further comprising a storage to:
store a copy of the streamed content; and
store the content rating information for the streamed content.

17. The content-playing device of claim 15, wherein the content transmitter is to perform a negotiation with the content-display device to receive an indication that the content-display device supports filtering of streamed content based on rating information.

18. A method, comprising:
accepting, by a content-display device, from a content-playing device, a connection request to stream content from the content-playing device;
receiving, by the content-display device, from the content-playing device, streamed content which can be rendered on the content-playing device, and content-rating information of the streamed content; and
controlling, by the content-display device, display of streamed content by the content display module based on the received content-rating information.

19. The method of claim 18, wherein controlling display comprises preventing display of the streamed content.

20. The method of claim 18, further comprising providing, by the content-display device, an indication to the content-playing device that the content-display device supports filtering of streamed content based on rating information.

21. One or more computer-readable media containing instructions written thereon that, in response to execution on a content-display device, cause the content-display device to:
accept, from a content-playing device, a connection request to stream content from the content-playing device;
receive, from the content-playing device, streamed content which can be rendered on the content-playing device, and content-rating information of the streamed content; and
control display of streamed content by the content display module based on the received content-rating information.

22. The one or more computer-readable media of claim 21, wherein control display comprises prevent display of the streamed content.

23. The one or more computer-readable media of claim 21, wherein control display comprises compare the received content-rating information to pre-configured filter restrictions on the content-display device.

24. The one or more computer-readable media of claim 21, wherein the instructions are further to cause the content-display device to provide an indication to the content-playing device that the content-display device supports filtering of streamed content based on rating information.

25. The one or more computer-readable media of claim 24, wherein provide an indication to the content-playing device that the content-display device supports filtering comprises negotiate with the content-playing device to determine content-filtering capabilities of the content-display device.
